(19) United States
(12) Patent Application Publication
(10) Pub. No.: US 2018/0081357 A1
(43) Pub. Date: Mar. 22, 2018

(54) GEOCODED INFORMATION AIDED VEHICLE WARNING

(71) Applicant: Ford Global Technologies, LLC, Dearborn, MI (US)

(72) Inventors: Somak Datta Gupta, Canton, MI (US); Brad Ignaczak, Canton, MI (US); Cynthia M. Neubecker, Westland, MI (US); Haron Abdel-Raziq, Dearborn, MI (US); Maeen Mawari, Dearborn, MI (US)

(21) Appl. No.: 15/267,682

(22) Filed: Sep. 16, 2016

(51) Int. Cl. G05D 1/00; G05D 1/02; B60R 25/01

(52) U.S. Cl. CPC G05D 1/0055; B60R 25/01; G05D 1/021

(57) ABSTRACT

Methods and apparatus are disclosed for geocoded information aided vehicle warning. An example disclosed vehicle includes range detection sensors and a threat detector. The example threat detector determines a threat level based on a location of the vehicle. Additionally, the example threat detector defines, with the range detection sensors, contours of detection zones around the vehicle based on the threat level. The example threat detector also performs first actions, via a body control module, to secure the vehicle in response to a threat detected in the detection zone.

### TECHNICAL FIELD

The present disclosure generally relates to vehicle safety systems and, more specifically, geocoded information aided vehicle warning.

### BACKGROUND

When stopped, drivers may engage in activities, such as check email or social media, that reduce their awareness of the area surrounding the vehicle. Additionally, increased sound noise external noise suppression in the cabin of the vehicle may also reduce awareness.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are disclosed for geocoded information aided vehicle warning. An example disclosed vehicle includes range detection sensors and a threat detector. The example threat detector determines a threat level based on a location of the vehicle. Additionally, the example threat detector defines, with the range detection sensors, contours of detection zones around the vehicle based on the threat level. The example threat detector also performs first actions, via a body control module, to secure the vehicle in response to a threat detected in the detection zone.

An example method to detect objects near a vehicle includes determining a threat level based on a location of the vehicle. The method also includes defining, with range detection sensors, contours of detection zones around the vehicle based on the threat level. Additionally, the method includes performing first actions, via a body control module, to secure the vehicle in response to the object detected in the detection zone.

An example tangible computer readable medium comprising instructions that, when executed, cause the vehicle to determine a threat level based on a location of the vehicle. The example instructions also cause the vehicle to define, with range detection sensors, contours of detection zones around the vehicle based on the threat level. Additionally, the instructions cause the vehicle to perform first actions, via a body control module, to secure the vehicle in response to the object detected in the detection zone.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates a vehicle with detection zones operating in accordance with the teachings of this disclosure.

FIG. 2 illustrates the vehicle of FIG. 1 with certain detection zones activated.

FIG. 3 is a block diagram of electronic components of the vehicle of FIGS. 1 and 2.

FIG. 4 is a flowchart of a method to detect threats around the vehicle of FIGS. 1 and 2 that may be implemented by the electronic components of FIG. 3.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

A vehicle includes sensors (e.g. range detection sensors, cameras, infrared sensors, etc.) to monitor its surroundings. Based on the sensors, the vehicle classifies detected objects (e.g. another vehicle, a pedestrian, etc). and provides real-time tracking of the detected objects. Additionally, the vehicle performs threat classification and responds to detected threats. For example, the vehicle may sound an alarm, provide text-to-speech based specific warnings, close windows, lock doors, capture images, and/or automatically call to law enforcement, etc. As another example, the vehicle may autonomously move to a safer location.

Additionally, the vehicle either (a) includes a receiver for a global navigation satellite system (e.g., a global positioning system (GPS) receiver, a Global Navigation Satellite System (GLONASS) receiver, Galileo Positioning System receiver, BeiDou Navigation Satellite System receiver, etc.) and/or a on-board communication system that connects to external networks, or (b) communicatively coupled to a mobile device (e.g., a phone, a smart watch, a tablet, etc.) that provides coordinates and a connection of an external network. The vehicle uses cloud-based information to determine a threat level. The cloud-based information includes, for example, the location of the vehicle, the local crime rate, geo-coded security metrics, work zones, weather, and school timing, etc. The vehicle uses the threat level to define contours of a boundary zones around the vehicle in which to the vehicle will detect, identify, and track objects.

To define contours of boundaries, the vehicle divides the area around the vehicle into zones. For example, the area around the vehicle may be divided into quadrants with a front driver's side quadrant, a front passenger's side quadrant, a rear driver's side quadrant, a rear passenger's side quadrant. Additionally, the vehicle adjusts a detection range around the vehicle. For example, the vehicle may, based on the threat level, react to objects detected within five feet of the vehicle. For example, at a drive through window of a fast food restaurant, the vehicle may only detect threats in the front and rear passenger's side quadrants. In such as manner, the vehicle tailors its threat detection and reaction to its location and minimizes false alarms.

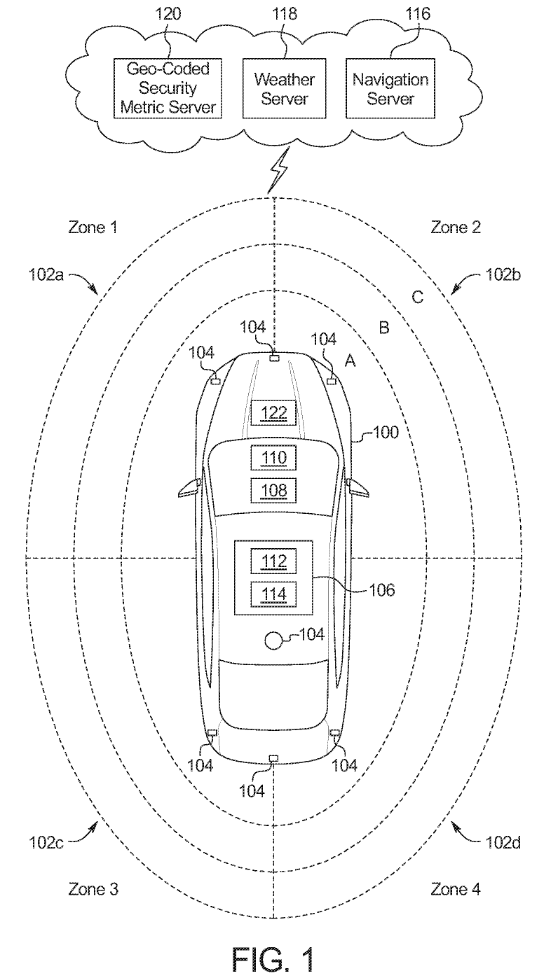

FIG. 1 illustrates a vehicle 100 with detection zones 102a-102d operating in accordance with the teachings of this disclosure. The vehicle 100 (e.g., a car, a truck, a motorcycle, a train, a boat, etc.) may be a standard gasoline powered vehicle, a hybrid vehicle, an electric vehicle, a fuel cell vehicle, and/or any other mobility implement type of vehicle. The vehicle 100 includes parts related to mobility, such as a powertrain with an engine, a transmission, a suspension, a driveshaft, and/or wheels, etc. The vehicle 100 may be non-autonomous, semi-autonomous (e.g., some routine motive functions controlled by the vehicle 100), or autonomous (e.g., motive functions are controlled by the vehicle 100 without direct driver input). In the illustrated example the vehicle 100 includes range detection sensors 104, an on-board communications platform 106, a body control module 108, and a threat detector 110.

The range detection sensors 104 are arrange around the vehicle 100. The range detection sensors 104 detect objects around the vehicle 100. The range detection sensors 104 include ultrasonic sensors, RADAR, LiDAR, cameras, and/or infrared sensors, etc. Different types of the range detection sensors 104 have different ranges that monitor different areas around the vehicle 100 that may be used singly or in conjunction to detect objects in the detection zones 102a-102d defined by the threat detector 110. Additionally, in some examples, the range detection sensors 104 have adjustable ranges. In some such example, the ranges are adjusted by adjusting a power level of the range detection sensor 104. Additionally, the range detection sensors 104 have detection arc based on how a particular range detection sensor 104 is installed on the vehicle 100. For example, one of the range detection sensors 104 may be mounted on the front bumper of the vehicle 100 and have a 90 degree detection arc. The range detection sensors 104 may be selected based on its range and its detection arc. For example, the ultrasonic sensors may have a relatively short range of 2 to 3 meters (e.g., 6.5 to 9.8 feet) and detect objects in the front and back of the vehicle 100 and the LiDAR may have a range of 150 meters (492 feet) with a 360 degree detection arc.

The on-board communications platform 106 includes wired or wireless network interfaces to enable communication with external networks. The on-board communications platform 106 also includes hardware (e.g., processors, memory, storage, antenna, etc.) and software to control the wired or wireless network interfaces. In the illustrated example, the on-board communications platform 106 includes one or more communication controllers 112 for standards-based networks (e.g., Global System for Mobile Communications (GSM), Universal Mobile Telecommunications System (UMTS), Long Term Evolution (LTE), Code Division Multiple Access (CDMA), WiMAX (IEEE 802.16m); Near Field Communication (NFC); local area wireless network (including IEEE 802.11 a/b/g/n/ac or others), dedicated short range communication (DSRC), and Wireless Gigabit (IEEE 802.11ad), etc.). In some examples, the on-board communications platform 106 includes a wired or wireless interface (e.g., an auxiliary port, a Universal Serial Bus (USB) port, a Bluetooth® wireless node, etc.) to communicatively couple with a mobile device (e.g., a smart phone, a smart watch, a tablet, etc.). In such examples, the vehicle 100 may communicate with the external network via the coupled mobile device. The external network(s) may be a public network, such as the Internet; a private network, such as an intranet; or combinations thereof, and may utilize a variety of networking protocols now available or later developed including, but not limited to, TCP/IP-based networking protocols. The on-board communications platform 106 also includes a GPS receiver 114 to provide the coordinates of the vehicle 100. While the term “GPS receiver” is used here, the GPS receiver 114 may be compatible with any suitable global navigation satellite system.

The vehicle 100, via the communication controller 112, receives information from a navigation server 116 to receive traffic, navigation, and/or landmark (e.g., parks, schools, gas stations, etc.) data, and/or a weather server 118 to receive weather data. The navigation server 116 may be maintained by a mapping service (e.g., Google® Maps, Apple® Maps, Waze®, etc.). The weather server 118 may be maintained by a government organization (e.g., the National Weather Service, the National Oceanic and Atmospheric Administration, etc.) or a commercial weather forecast provider (e.g., AccuWeather®, Weather Underground®, etc.). Alternatively or additionally, in some examples, the vehicle 100 communicates with a geo-coded security metric server 120. The geo-coded security metric server 120 provides security metrics that are associated with coordinates. The security metric provides an assessment of how safe the area is. In such examples, the geo-coded security metric server 120 receives information from various sources, such as the navigation server 116, the weather server 118, a real estate database, and/or a crime statistics database, etc. to assign regions (e.g., coded map tiles, etc.) the security metric. In some such examples, the security metric is a value between 1 (not safe) to ten (very safe). For example, a strong storm may temporarily increase the security metric of an area. The geo-coded security metric server 120 maybe maintained by any suitable entity, such as a government organization, a vehicle manufacturer, or an insurance company, etc. In some examples, the vehicle 100 retrieves the data (e.g., the weather data, the navigation data, the security metrics, etc.) from the servers 116, 118, and 120 via an application programming interface (API).

The body control module 108 controls various subsystems of the vehicle 100. For example, the body control module 108 may control power windows, power locks, an immobilizer system, and/or power mirrors, etc. The body control module 108 includes circuits to, for example, drive relays (e.g., to control wiper fluid, etc.), drive brushed direct current (DC) motors (e.g., to control power seats, power locks, power windows, wipers, etc.), drive stepper motors, and/or drive LEDs, etc. The body control module 108 is communicatively coupled to input controls within the vehicle 100, such as power window control buttons, power lock buttons, etc. The body control module 108 instructs the subsystem to act based on the corresponding to the actuated input control. For example, if the driver's side window button is toggled to lower the driver's side window, the body control module 108 instructs the actuator controlling the position of the driver's side window to lower the window. In the illustrated example, the body control unit is communicatively coupled to an alarm 122. The alarm 122 produces an audio alert (e.g., a chime, a spoken message, etc.) to warn occupants of the vehicle 100 of an approaching threat. In some examples, the audio alert may be tailored to the detected threat. For example, the alarm 122 may say, “Object detected approaching vehicle from the rear passenger's side quadrant.”

The threat detector 110 establishes the detection zones 102a-102d and monitors for objects approaching the vehicle 100. The threat detector 110 determines the contours of the detection zones 102a-102d based on the security metric received from the geo-coded security metric server 120. The threat detector 110 sends the coordinates (e.g. received from the GPS receiver 114) to the geo-coded security metric server 120 and receives the geo-coded security metric and/or location information. In some examples, to define the detection zones 102a-102d, the threat detector 110 selects which ones of the range detection sensors 104 to activate and at which power level to activate them. Alternatively or additionally, the threat detector 110 activates the range detection sensors and reacts to objects within the selected detection zones 102a-102d. To detect threats, the threat detector 110 monitors movement via the range detection sensors 104. Additionally, when the range detection sensors 104 include cameras and/or a LiDAR, the threat detector 110 identifies and/or categorizes detected objects.

Additionally, the threat detector 110 responds to detected objects based on the security level. The threat detector 110 is communicatively coupled to the body control module 108. When a threat is detected in one of the selected detection zones 102a-102d, the threat detector 110 instructs the body control module 108 to act to mitigate the threat. For example, the threat detector 110 may instruct the body control module 108 to close the windows, lock the doors, and/or provide an alert (via the alarm 122). In some examples, the threat detector 110 instructs the sound system to lower the volume. In some examples, when the vehicle 100 is autonomous or semi-autonomous, the threat detector 110 instructs an autonomy unit (not shown) that controls the vehicle 100 to maneuver the vehicle 100 away from the detected threat.

Additionally, in some examples, in response to detecting a threat, the threat detector 110 transmits, via the on-board communications platform 106, a notification to one or more mobile devices (e.g., a smart phone, a smart watch, etc.) paired with the vehicle 100. In some such examples, the notification may cause a radar map to be displayed on the mobile device with the location of the detected threat marked in relation to the location of the vehicle 100. In some such examples, the threat detecter 110 determines whether the driver is in the vehicle 100 (e.g., by detecting whether the key fob is in the vehicle 100), and sends the notification if the driver is not in the vehicle 100. Further, in some examples, the threat detector 110 broadcasts a notification, via the on-board communications platform 106, to other vehicles within range that provides the location (e.g., the coordinates) of the vehicle 100 and the location of the detected threat. In some examples, the threat detector 110 sends notifications to a thirty party (e.g., not the driver or an occupant of the vehicle 100) based on (i) the location of the vehicle 100 and (ii) the characteristics and/or features of the location. For examples, if a feature of the location is an automated teller machine (ATM), the threat detector 110 may send a notification to a third party such as local police department, a bank that owns the ATM, and/or a mapping service.

In a first example scenario, the vehicle 100 may be driving at a slow speed or stopped at traffic light. The vehicle 100, via the on-board communications platform 106, requests the geo-coded security metric. System adjusts sensitivity of the range detection sensor 104 to define the size and shape of the detection zones 102a-102d to take into account the geo-coded security metric and the likelihood of other vehicles in the proximity of the vehicle 100. When a person approaches the vehicle 100, the threat detector 110 instructs the body control module 108 to lock the doors and close the window.

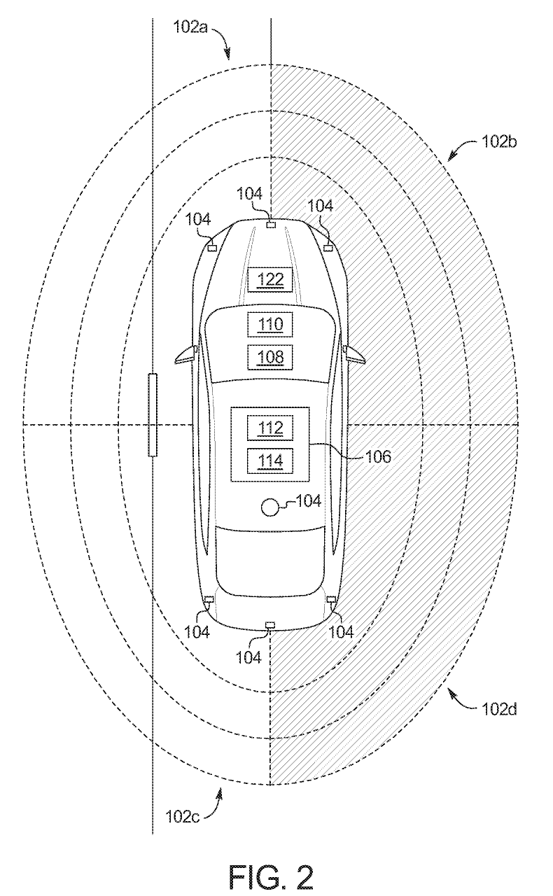

In a second example scenario illustrated in FIG. 2, the vehicle 100 may be at a fast food drive thru. Threat approaches vehicle when it is in a Drive Thru. The threat detector 110 checks the geo-coded security metric and determines that the vehicle 100 is at a drive thru. The threat detector 110 adjusts sensitivity of the range detection sensors 104 to define the size and shape of the detection zones 102a-102d. In example illustrated in FIG. 2, because the restaurant and drive thru window are on the driver's side, the threat detector 110 adjusts the range detection sensors 104 to monitor the passenger's side (e.g., the front passenger's side detection zone 102b and the rear passenger's side detection zone 102d.

In a third example scenario, the threat detector 110 may determine that the vehicle 100 is in a construction zone based on data from the navigation server 116. The threat detector 110 increases the range of the front detection zones 102a-102b to detect construction workers with enough forewarning for the driver to response. Upon detecting a construction worker, the threat detector 110 instructs the body control module 108 to provide an alert (via the alarm 122) and/or instruct a brake control unit (not shown) apply the brakes to slow the vehicle 100.

In a fourth example scenario, the threat detector 110 determines, with data from the weather server 118, that the vehicle 100 is driving through a region where vision is impaired by fog, dust or low light. The threat detector 110 uses specific range detection sensors 104, such as infrared sensors, to monitor the selected detection zones 102a-102d. The threat detector 110 responds to detected objects based on the geo-coded security metric from the geo-coded security metric server 120. For example, the threat detector 110 may instruct the body control module 108 to lock the doors and provide an alert.

In a fifth example scenario, the threat detector 110 determines, with data from the navigation server 116, that the vehicle 100 is driving through a school zone. Additionally, the threat detector 110 determines, from, for example, the navigation server 116, the school timings to adjust the range detection sensors 104 for a higher probability of children-sized objects. When a threat (e.g., a child) is detected, the threat detectors instruct the body control module 108 to provide an alert. For example, the alarm may say, “Child detected at the rear of the vehicle.”

In a sixth example scenario, while reversing from a driveway or parking lot, the threat detector 110 may adjust the detection zones 102c-102d to detect multiple targets approaching the vehicle. For example, the targets may be vehicles, pedestrians, and/or cyclists. The example threat detector may display the targets on a radar map (e.g., displayed by an infotainment system) relative to the vehicle 100, color code the targets based on distance/speed, and activate the alarm 122 to alert the driver.

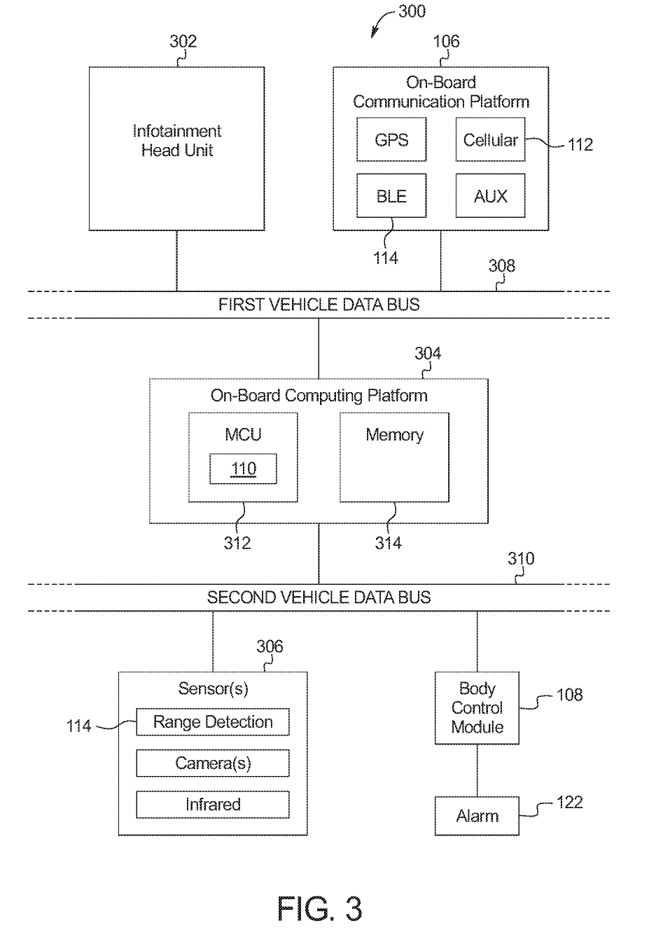

FIG. 3 is a block diagram of electronic components 300 of the vehicle 100 of FIGS. 1 and 2. In the illustrated example, the electronic components 300 include the on-board communications platform 106, the body control module 108, the alarm 122, an infotainment head unit 302, an on-board computing platform 304, sensors 306, a first vehicle data bus 308, and a second vehicle data bus 310.

The infotainment head unit 302 provides an interface between the vehicle 100 and a user. The infotainment head unit 302 includes digital and/or analog interfaces (e.g., input devices and output devices) to receive input from the user(s) and display information. The input devices may include, for example, a control knob, an instrument panel, a digital camera for image capture and/or visual command recognition, a touch screen, an audio input device (e.g., cabin microphone), buttons, or a touchpad. The output devices may include instrument cluster outputs (e.g., dials, lighting devices), actuators, a heads-up display, a center console display (e.g., a liquid crystal display (“LCD”), an organic light emitting diode (“OLED”) display, a flat panel display, a solid state display, etc.), and/or speakers. In the illustrated example, the infotainment head unit 302 includes hardware (e.g., a processor or controller, memory, storage, etc.) and software (e.g., an operating system, etc.) for an infotainment system (such as SYNC® and MyFord Touch® by Ford®, Entune® by Toyota®, IntelliLink® by GMC®, etc.). Additionally, the infotainment head unit 302 displays the infotainment system on, for example, the center console display. In some examples, the threat detector 110 provides a visual alert and/or a radar-like display via the infotainment system.

The on-board computing platform 304 includes a processor or controller 312 and memory 314. In some examples, the on-board computing platform 304 is structured to include the threat detector 110. Alternatively, in some examples, the threat detector 110 may be incorporated into another electronic control unit (ECU) with its own processor and memory, such as the body control module 108 or an Advanced Driver Assistance System (ADAS). The processor or controller 312 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory 314 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory 314 includes multiple kinds of memory, particularly volatile memory and non-volatile memory.

The memory 314 is computer readable media on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory 314, the computer readable medium, and/or within the processor 312 during execution of the instructions.

The terms “non-transitory computer-readable medium” and “computer-readable medium” should be understood to include a single medium or multiple media, such as a centralized or distributed database, and/or associated caches and servers that store one or more sets of instructions. The terms “non-transitory computer-readable medium” and “computer-readable medium” also include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The sensors 306 may be arranged in and around the vehicle 100 in any suitable fashion. The sensors 306 may measure properties around the exterior of the vehicle 100. Additionally, some sensors 306 may be mounted inside the cabin of the vehicle 100 or in the body of the vehicle 100 (such as, the engine compartment, the wheel wells, etc.) to measure properties in the interior of the vehicle 100. For example, such sensors 306 may include accelerometers, odometers, tachometers, pitch and yaw sensors, wheel speed sensors, microphones, tire pressure sensors, and biometric sensors, etc. In the illustrated example, the sensors include the range detection sensors 104.

The first vehicle data bus 308 communicatively couples the on-board computing platform 304, the sensors 306, the body control module 108, and other devices (e.g., other ECUs, etc.) connected to the first vehicle data bus 308. In some examples, the first vehicle data bus 308 is implemented in accordance with the controller area network (CAN) bus protocol as defined by International Standards Organization (ISO) 11898-1. Alternatively, in some examples, the first vehicle data bus 308 may be a Media Oriented Systems Transport (MOST) bus, or a CAN flexible data (CAN-FD) bus (ISO 11898-7). The second vehicle data bus 310 communicatively couples the on-board communications platform 106, the infotainment head unit 302, and the on-board computing platform 304. The second vehicle data bus 310 may be a MOST bus, a CAN-FD bus, or an Ethernet bus. In some examples, the on-board computing platform 304 communicatively isolates the first vehicle data bus 308 and the second vehicle data bus 310 (e.g., via firewalls, message brokers, etc.). Alternatively, in some examples, the first vehicle data bus 308 and the second vehicle data bus 310 are the same data bus.

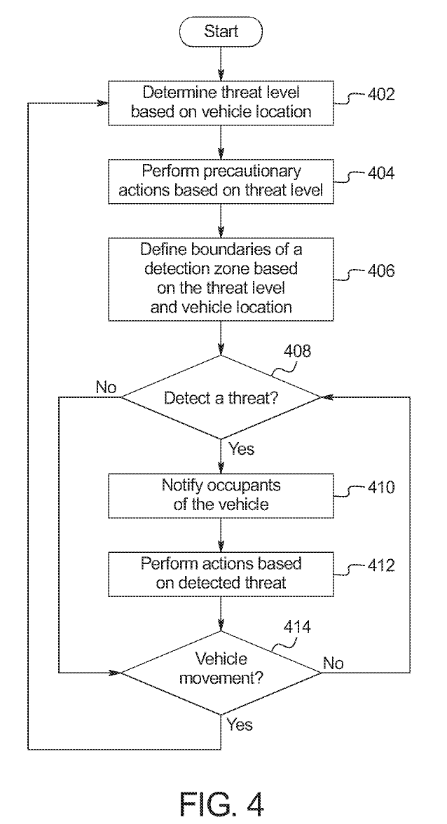

FIG. 4 is a flowchart of a method to detect threats around the vehicle 100 of FIGS. 1 and 2 that may be implemented by the electronic components 300 of FIG. 3. Initially, at block 402, the threat detector 110 determines a threat level based on the location of the vehicle 100. In some examples, the threat detector determines the threat level based on a security metric received from the geo-coded security metric server 120. Alternatively or additionally, the threat detector 110 determines the threat level based on information from the navigation server 116 and/or the weather server 118. At block 404, the threat detector 110, via the body control module 108, performs precautionary action based on the threat level. For example, the threat detector 110 may instruct the body control module 108 to lock the doors. At block 406, the threat detector 110 defines boundaries of the detection zone 102a-102d based on the threat level and the location of the vehicle 100. For example, the threat detector 110 may select which of the range detection sensors 104 to activate and/or may define the size and shape of the detection zones 102a-102d by adjust the power level to the selected range detection sensors 104.

At block 408, the threat detector 110 monitors the detection zones 102a-102d zones defined at block 406. If the threat detector 110 detects a threat, the method continues at block 410. Otherwise, if the threat detector 110 does not detect a threat, the method continues at block 414. At block 410, the threat detector, via the alarm 122 and/or the infotainment head unit 302, notifies the occupants of the vehicle 100 of the detected threat. For example, an alarm may be displayed on the center console display and/or a chime may be played by the alarm 122. At block 412, the threat detector 110 performs actions based on the detected threat. For example, the threat detector 110 may instruct the body control module 108 to close the windows and/or an autonomy unit to maneuver the vehicle 100 away from the threat. At block 414, the threat detector 110 determines whether the vehicle 100 is at a new location. If the vehicle 100 is at a new location, the method returns to block 402. Otherwise, if the vehicle 100 is not at a new location, the method returns to block 408.

The flowchart of FIG. 4 is a method that may be implemented by machine readable instructions that comprise one or more programs that, when executed by a processor (such as the processor 312 of FIG. 3), cause the vehicle 100 to implement the threat detector 110 of FIG. 1. Further, although the example program(s) is/are described with reference to the flowchart illustrated in FIG. 4, many other methods of implementing the example threat detector 110 may alternatively be used. For example, the order of execution of the blocks may be changed, and/or some of the blocks described may be changed, eliminated, or combined.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

1. A vehicle comprising:
range detection sensors; and
a threat detector to:
establish, with the range detection sensors, quadrants around the vehicle;
determine a threat level based on a location of the vehicle;
define a detection zone by selecting the quadrants utilizing the location and a detection range utilizing the threat level; and
perform first actions, via a body control module, to secure the vehicle in response to a threat detected in the detection zone.

2. The vehicle of claim 1, wherein the threat level is based on a geo-coded security metric, navigation data, and weather data retrieved from an external network.

3. The vehicle of claim 1, wherein the threat detector is to, in response to the threat detected in the detection zone, provide a notification to a mobile device paired with the vehicle that causes a radar map to be displayed on the mobile device with the location of the threat relative to the location of the vehicle.

4. The vehicle of claim 1, wherein the threat detector is to, in response to the threat detected in the detection zone:
detect whether a driver is inside the vehicle; and
when the driver is not inside the vehicle, provide a notification to a mobile device associated with the driver that is paired with the vehicle, the notification causing a radar map to be displayed on the mobile device with the location of the threat relative to the location of the vehicle.

5. The vehicle of claim 1, wherein the range detection sensors include a first range detection sensor and a second range detection sensor, the first and second range detection sensors being different types of sensors.

6. The vehicle of claim 5, wherein to select the detection range, the threat detector is to:
select the first range detection sensor or the second range detection sensor wherein the detection range is a range capability for the selected one of the range detection sensors.

7. The vehicle of claim 6, wherein the threat detector is to select the first range detection sensor or the second range detection sensor based on at least one of weather data, the range capability of the range detection sensors, or detection arcs of the range detection sensors.

8. The vehicle of claim 1, wherein the threat detector is to perform second actions, via the body control module, to secure the vehicle before the threat is detected.

9. The vehicle of claim 8, wherein the first actions include closing windows and providing an alarm, and wherein the second actions include locking doors and lowering a volume of a sound system.

10. The vehicle of claim 1, wherein the vehicle is autonomous or semi-autonomous; and wherein the threat detector is to, in response to detecting the threat in the detection zone, instruct the vehicle to maneuver away from the threat.

11. The vehicle of claim 1, wherein the threat detector is to, in response to the threat detected in the detection zone, broadcast a notification to a third party based on a feature at the location of the vehicle.

12. A method to detect objects near a vehicle comprising:
defining, with the range detection sensor, quadrants around the vehicle;
determining, with a processor, a threat level based on a location of the vehicle;
establishing a detection zone around the vehicle by selecting one or more of the quadrants based on the location of the vehicle and a detection range based on the threat level; and
performing first actions, via a body control module, to secure the vehicle in response to the object detected in the detection zone.

13. The method of claim 12, wherein the threat level is based on a geo-coded security metric, navigation data, a current time of day, and weather data retrieved from an external network.

14. The method of claim 12, including, in response to the threat detected in the detection zone:
detecting whether a driver is inside the vehicle; and
when the driver is not inside the vehicle, providing a notification to a mobile device associated with the driver that is paired with the vehicle, the notification causing a radar map to be displayed on the mobile device with the location of the threat relative to the location of the vehicle.

15. The method of claim 12, wherein the range detection sensors include a first range detection sensor and a second range detection sensor, the first and second range detection sensors being different types of sensors.

16. The method of claim 15, wherein selecting the detection range includes:
selecting the first range detection sensor or the second range detection sensor, wherein the detection range is based on a range capability for the selected one of the range detection sensors.

17. The method of claim 16, including selecting the first range detection sensor or the second range detection sensor based on at least one of weather data, the range capability of the range detection sensors, or detection arcs of the range detection sensors.

18. The method of claim 12, wherein the threat detector is to perform second actions, via the body control module, to secure the vehicle before the threat is detected.

19. The method of claim 18, wherein the first actions include closing windows and providing an alarm, and wherein the second actions include locking doors and lowering a volume of a sound system.

20. The method of claim 12, wherein the vehicle is autonomous or semi-autonomous; and including, in response to detecting the threat in the detection zone, instructing the vehicle to maneuver away from the threat.

21. The vehicle of claim 1, wherein the threat detector is to:
establish, with the range detection sensors, range increments around the vehicle; and
select the detection range by selecting one of the range increments, wherein the selected quadrant and the selected range increment in combination define the detection zone.
